(19) United States
(12) Patent Application Publication
(10) Pub. No.: US 2013/0341578 A1
(43) Pub. Date: Dec. 26, 2013

(54) Line Hauler with Dualler Plate and Line Coiler

(71) Applicant: Michael Noah Mosdell, Nanaimo (CA)

(72) Inventor: Michael Noah Mosdell, Nanaimo (CA)

(21) Appl. No.: 13/852,340

(22) Filed: Mar. 28, 2013

Related U.S. Application Data
(60) Provisional application No. 61/663,891, filed on Jun. 25, 2012.

(51) Int. Cl. A01K 73/12; B66D 1/12

(52) U.S. Cl. CPC A01K 73/12; B66D 1/12
USPC 254/362

(57) ABSTRACT

An improved line hauler is provided that has a dualler plate located between the two plates of the sheave. The dualler plate creates two V-channels for the line and the line therefore can be directed on a path that results in a hands free line hauler that is slip free. A line coiler is also provided that promotes coiling of the line as it drops to the boat deck.

### CROSS REFERENCE TO RELATED PATENT APPLICATIONS

This application is related to, and claims the benefit of, U.S. Provisional Patent Application No. 61/663,891, filed Jun. 25, 2012. The above-identified priority patent application is incorporated herein by reference in its entirety.

### FIELD

The present technology relates to a line hauler having a dualler plate and deflector to allow for hands free hauling of lines. More specifically, the technology is a kit comprising a dualler plate and a deflector as an improvement over existing line haulers.

### BACKGROUND

Line haulers are used on commercial fishing vessels to haul in crab pots, prawn pots and fish. They are usually very large and have features that are necessary for hauling in very large catches. There are also line haulers for individuals to use on a much smaller scale. One such hauler is the Ace Line Hauler Brutus Plus 40®.

Regardless of the size of the hauler, there are a number of features that are common. A typical hauler generally has a motor for driving a sheave, which hauls the line in. The sheave is usually V-shaped sheave for gripping the line. Pulleys and various positioners are disclosed. Some have line coilers.

U.S. Pat. No. 4,354,667 discloses pivotal support bearings that permit the unit to revolve freely about a fixed bearing axis in addressing itself to the incoming line being hauled and that restrain the unit against other bodily motion.

The V-shaped sheave can cause the line to remain in the sheave, especially if there are knots along the line. U.S. Pat. No. 3,034,767 discloses a separator that projects upwardly into the sheave, to separate the line from the V groove of the sheave. It also comprises a sloping shoulder to deflect and direct the outgoing line from the bight before it leaves the sheave in the normal direction in which the sheave rotates.

One prior device for laying up hauled lines in coils is disclosed in U.S. Pat. No. 3,750,970. In that case the line fed downwardly into the receiving barrel or tub was guided through a rotating deflection tube or slinger directing the line outwardly by centrifugal force so as to form a descending spiral to make up the accumulating coil.

In U.S. Pat. No. 4,165,830 it is disclosed that the line thrust fed downwardly from a generally central position into a cylindrical bin by a combination of two sheaves and a pneumatic tire roller means will assume a coiled configuration in the container of sufficient orderliness for practical purposes and that in performing this operation the apparatus accommodates also the heavy and bulky shot-connecting knots, even at the highest hauling rates used in this fishery.

### SUMMARY

A line hauler with dualler plate is provided to assist a user in hauling lines holding seafood traps. The line hauler reduces the need for the user to haul in the lines as it reduces or eliminates slippage of the line. The line hauler comprises a stand, a first pulley, a second pulley and a sheave, the sheave comprising two sides and a groove therebetween, a drive shaft, an electric motor for driving the sheave rotationally with the drive shaft, the improvement being a dualler plate and retainers, the dualler plate comprising a circular stainless steel plate, a central aperture for accepting the drive shaft and apertures corresponding to apertures in the sheave for accepting the retainers, the dualler plate dividing the groove into a first V-channel and a second V-channel, such that in use, a line is fed from the upper side of the first pulley to an upper side of the first V-channel, to a lower side of the second pulley, and returning to the sheave on an upper side of the second V-channel.

In use, the line hauler further comprises the line, the line being fed from the upper side of the first pulley to the upper side of the first V-channel, to the lower side of the second pulley, and returning to the sheave on the upper side of the second V-channel.

The V-channels of the line hauler are preferably 0.5 inches wide at the outer edge and about 1.5 inches deep.

It is preferred that the dualler plate is sized to match the plates, and is therefore about 8 inches to about 11 inches in diameter.

The line hauler preferably comprises a line coiler, the line coiler comprising a first section affixed to the line hauler, a second section at right angles to the first section, sloped about 16 to about 21 degrees towards the sheave and adjacent at least the second V-channel and an end section at about 43 to about 47 degrees to the second section, proximate the second V-channel and angled away from the sheave, wherein the line is threaded between the first V-channel and line coiler and is fed over the line coiler from the second V-channel, such that in use, the line coiler is urged to coil.

The line coiler can alternatively be described as having an attachment member attached to the line hauler, a directing member extending therefrom proximate the second V-channel and configured to direct a line from the second V-channel, and an end member extending from the second member, the end member essentially parallel to the V-channels.

The line coiler may also include an O-ring seated in the second V-channel.

As fishers may already have a line hauler, it is advantageous to provide a kit for use with a line hauler, the line hauler comprising a stand, a first pulley, a second pulley and a sheave, the sheave comprising two sides and a groove therebetween, a drive shaft, an electric motor for driving the sheave rotationally with the drive shaft, the kit comprising: a rotatable member for increasing friction on a line; retainers; and a line coiler.

The line coiler comprises a first section for affixing to the line hauler, a second section angled at about 85 degrees to about 95 degrees to the first section and a third section that is angled at about 43 to about 90 degrees from the second section to encourage a line to remain on the line coiler and return back over the second section, such that in use, the line coiler extends outward and downward from the line hauler.

More specifically, the rotatable member is a dualler plate, the dualler plate comprising a circular stainless steel plate, a central aperture for accepting the drive shaft and apertures corresponding to apertures in the sheave for accepting the retainers, the dualler plate for dividing the groove into a first V-channel and a second V-channel, such that in use, a line is fed from the upper side of the first pulley to an upper side of the first V-channel, to a lower side of the second pulley, and returning to the sheave on an upper side of the second V-channel.

The line coiler of the kit is further defined as follows: the first section is about 4 to about 6 inches long, the second section is at about 85 degrees to about 95 degrees to the first section, sloped about 16 to about 21 degrees from the plane of the first section and about 1.25 inches to about 2.25 inches long and the third section at about 43 to about 47 degrees to the second section and about 0.4 to about 1 inch long.

The kit of claim further comprises an O-ring for seating in the second V-channel.

A line coiler for use with a line hauler is also provided. The line coiler comprises a first section for affixing to the line hauler, a second section angled at about 85 degrees to about 95 degrees to the first section and a third section that is angled at about 43 to about 90 degrees from the second section to encourage a line to remain on the line coiler and return back over the second section, such that in use, the line coiler extends outward and downward from the line hauler.

A method of preparing and using a line hauler with a dualler plate is also provided, the method comprising:
attaching the dualler plate between a first plate and a second plate of a sheave to provide a first V-channel and a second V-channel;
feeding a line over a first pulley to the first V-channel, to an upper side of the first V-channel, to a lower side of the second pulley, and returning to the sheave on an upper side of the second V-channel.

Preferably, the line hauler comprises a line coiler, and therefore the method further comprises threading the line between the line coiler and the first V-channel, to a lower side of the second pulley, returning to the sheave on an upper side of the second V-channel and over the line coiler.

### FIGURES

FIG. 1 is a prior art line hauler.

FIG. 2 is a view of the sheave with dualler plate and line coiler.

FIG. 3 is a plan view of the dualler plate and the line coiler.

FIG. 4 is a view of the sheave with the dualler plate and line coiler.

FIG. 5 is a plan view showing routing of the line.

### DESCRIPTION

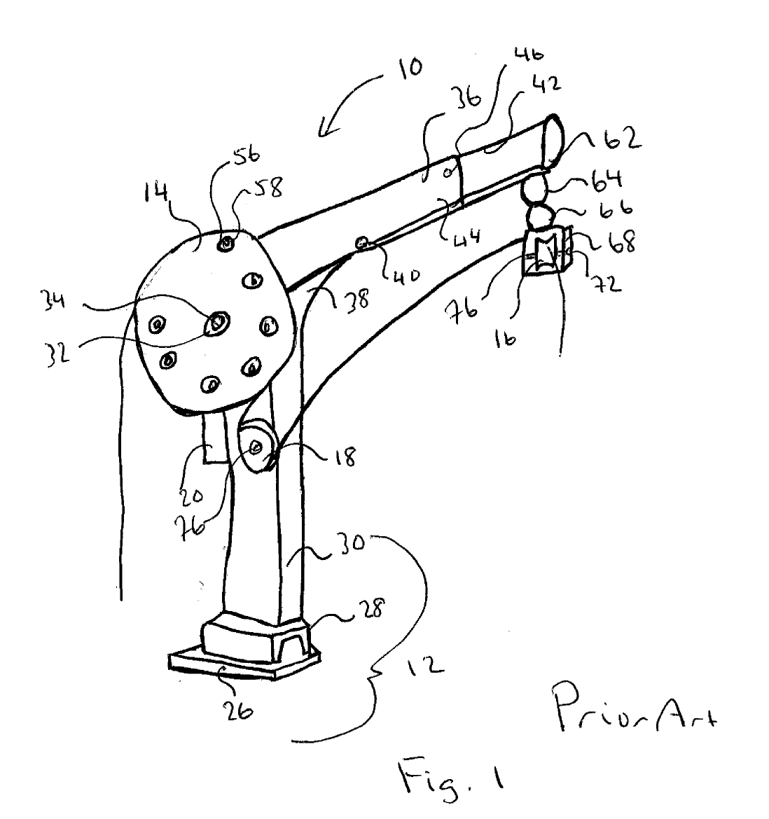

A line hauler, generally referred to as 10 is shown in FIG. 1. The line hauler has a stand 12, a sheave 14, a first pulley 16, a second pulley 18 and a motor 20. The stand 12 has a base plate 26, a saddle 28 for mounting onto the base plate 26 and for adjustably mounting an upright 30. The upright 30 is generally triangular in shape to accommodate the sheave 14 and motor 20. An aperture 32 extends through the upright 30 to accept a drive shaft 34. An arm 36 extends from the upright 30 and is braced with a brace 38. The arm 36 is retained with a cotter pin 40 to allow for easy folding. An arm extension 42 is housed in a sleeve 44 at the distal end of the arm 36. A cotter pin 46 retains the arm extension 42.

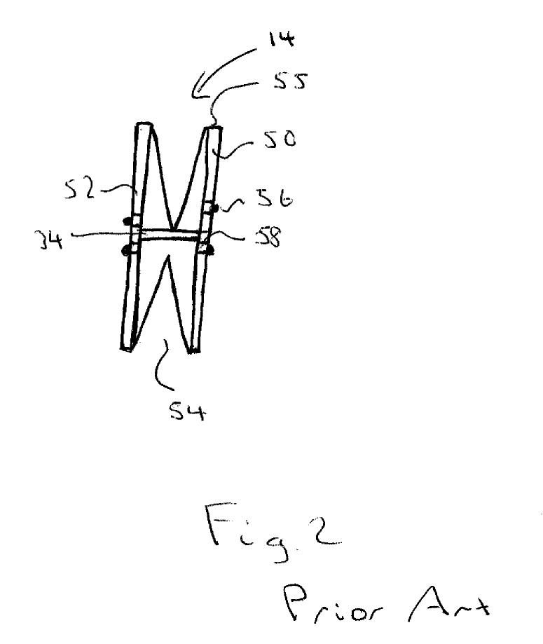

A standard prior art sheave 14, as provided by Ace Line Hauler™ can be seen in FIG. 2. The sheave 14 has a first plate 50 and second plate 52 and a V-groove 54 therebetween. The groove is 1.5 inches deep and 1 inch wide at the outer edge 55. The plates 50, 52 are bolted to one another by a series of bolts 56 that fit through a series of apertures 58. The drive shaft 34 is centrally located in the sheave 14 and is directly connected to the motor 20 to drive the sheave 14. The sheave 14, drive shaft 34 and motor 20 are mounted on the stand 12.

Returning to FIG. 1, a first pulley 60 is suspended from the distal end 62 of the arm extension 42 by a swivel 64, link 66 and hanger 68. A second pulley 70 is mounted on the upright 30. The hanger 68 has an aperture 72 to accept a pulley axle 74. The second pulley 70 is mounted on a pulley shaft 76 that is housed in an aperture 78 in the upright 30.

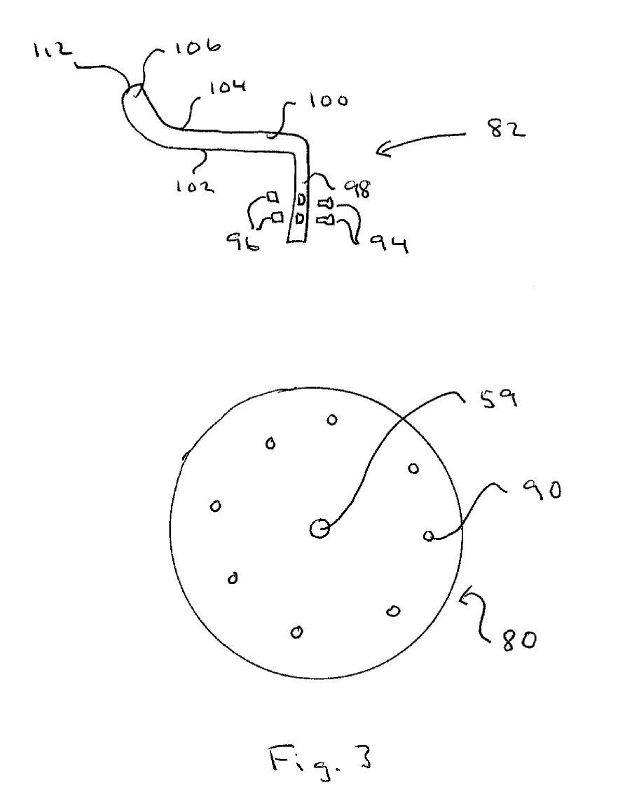

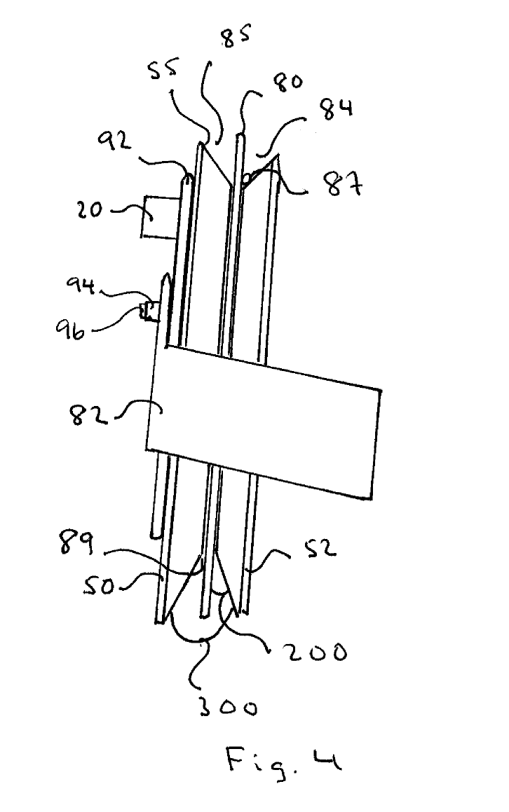

As shown in FIG. 4, the line hauler 10 is provided with a dualler plate 80 and a line coiler 82. The dualler plate 80 is located between the first plate 50 and the second plate 52 and divides the V-groove 54, hence providing two V-channels, a first V-channel 84 and a second V-channel 85, each having a much reduced angle at the bottom 89 of the V-channel (rather than the angle defined as 1 inch wide at the outer edge 55 over 1.5 inches of depth, the angle is about 0.5 inch wide at the outer edge 55 over about 1.5 inches of depth) (see FIG. 4 where angle 200 is about 32 to about 35 degrees, preferably about 33 degrees and angle 300 [the angle without the dualler plate] is about 66 degrees). The dualler plate 80 is a flat 11 inch diameter by 1/16 inch thick stainless steel plate (essentially the same dimensions as the plates 50, 52 of the sheave 14). As shown in FIG. 3, apertures 90 are for aligning with the apertures 58 of the standard sheave 14. A central aperture 59 is for accepting the drive shaft 34. The second V-channel 85 may be provided with a 3/16 inch to about ¼ inch O-ring 87 that seats in the bottom 89 of the V-channel 85.

The line coiler 82 is mounted on the motor frame 92 with 2.25 inch bolts 94 and nuts 96, as shown in FIG. 4. It extends straight from the frame 92. As shown in FIG. 3 it has a first section 98 that is about 5 inches long by about 1.5 inches wide by about 0.25 inches deep, a second section 100 approximately at right angles to the first section 98 that is about 1.75 inches long by about 1.5 inches wide by about 0.25 inches deep and is sloped about 0.5 inch down over its width, in other words, is at about an 18 degree angle relative to the first section 98, with the lower side 102 away from the sheave 14 and the upper side 104 proximate the sheave 14, and an end section 106 that is about 0.5 inches long by about 1.5 inches wide by about 0.25 inches deep that is bent away from the sheave 14 at about a 45 degree angle. Returning to FIG. 4, the line coiler 82 is positioned such that the second section 100 is aligned with at least the second V-channel 85 of the sheave 14.

The first section 98 is sized to extend from the frame 92 a sufficient distance to allow the second section 100 to be in front of the sheave 14, hence, depending on the mounting location, the section could be longer or shorter, but preferably it is about 4 inches to about 6 inches long, more preferably about 4.5 to about 6.5 inches long, and most preferably about 5 inches long. The second section 100 is sized to extend over at least the second V-channel 85 and therefore is about 1.25 inches to about 2.25 inches long, preferably about 1.5 inches to about 2 inches long and most preferably about 1.75 inches long. The end section 106 is designed to ensure that the line 110 does not skip over the end 112 and therefore it is at least about 0.4 inches long, preferably at least about 0.45 inches long and most preferably at least about 0.5 inches long. As it could catch a user's clothing, it is best to not be any longer than about 1 inch long. All the sections are made from 1.5 inch stock, however, the sections may be about 1 inch wide to about 2 inches wide, preferably about 1.25 inches to about 1.75 inches wide and most preferably about 1.5 inches wide. The thickness of the material should allow for bending of the stock and is therefore about 0.05 inches to about 0.15 inches thick, preferably about 0.07 to about 0.1 inches thick and most preferably about 0.09 inches thick.

The angle between the first section 98 and the second section 100 is disclosed as a right angle, which may be about 85 degrees to about 95 degrees, preferably about 87 degrees to about 92 degrees and most preferably about 90 degrees, however, if the first section 98 is mounted in an alternative location, the angle will be different and therefore is better described as an angle that permits mounting of the first section 98 such that the second section 100 is normal to the V-channels 84, 85.

The angle that the second section 100 is sloped away from the sheave 14 can be about 16 degrees to about 21 degrees, preferably about 17 degrees to about 20 degrees and most preferably about 18 degrees to about 19 degrees. The distance between the second section 100 and the outer edge 55 of the sheave is about 0.4 inches to about 0.7 inches, preferably about 0.5 inches to about 0.625 inches on the upper side 104 of the second section 100 and is preferably about 0.9 inches to about 1.35 inches, preferably 1 inch to about 1.25 inches on the lower side 102 of the second section 100. This can also be described as the angle from the plane 99 of the first section 98.

The angle between the second section 100 and end section 106 can be about 43 degrees to about 47 degrees, preferably about 44 degrees to about 46 degrees and most preferably about 45 degrees. The end section 106, therefore, is essentially parallel to the V-channels 84 and 85 and to the line 110 as it leaves the sheave 14.

The angle that the second section 100 is sloped and the angle of the end section 106 relative to the second section 100 determines the efficiency of the line coiler 82. Experimentation has shown that the range of angles that can be used effectively is very small. Angles outside of the cited range will not result in the line coiling as it comes off the sheave 14.

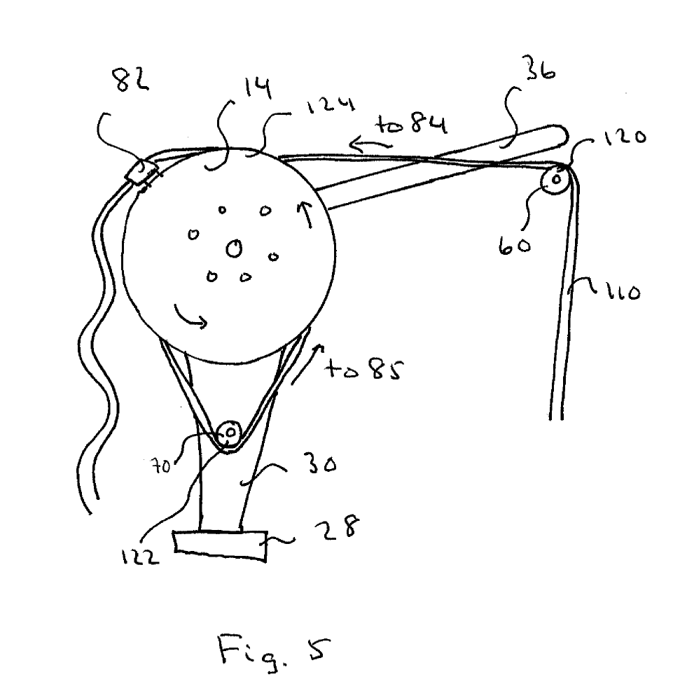

As shown in FIG. 5, the line 110 is routed through the line hauler 10 as follows: The line 110 enters into the first pulley 60 on an upper side 120 and then enters the first V-channel 84 of the sheave 14, which is the innermost V-channel, passing over the upper side 124 of the sheave 14 and down to the second pulley 70 on a lower side 122. From the lower side 122 of the second pulley 70, the line returns to the sheave 14, entering the second V-channel 85, passing over the upper side 124 of the sheave 14. The line is then fed over the second section 100 of the line coiler 82. The line 110 then self-coils on the floor of the boat, without requiring a bin or other circular vessel to assist in coiling the line 110.

The path of the line 110 on the pulleys 60, 70 and sheave 14 stops slippage of the line 110, which can trap the line, and without any human intervention. The line coiler coils the line, again without human intervention. Therefore, the two components provide for “hands free” operation of a line hauler. Without the dualler plate and the rope coiler, a user who has 4 prawn traps with 400 ft of line on each trap, would have to assist normal hauler operation, moving their hands, arms and shoulders 1200 to 1600 repetitions, each time they pulled the traps.

The foregoing is a description of an embodiment of the present technology. As would be known to one skilled in the art, variations that do not alter the scope of the technology are contemplated. For example, the line coiler may be attached to another component, or a different frame and therefore may be attached to the side opposite the motor, the requirement being that the second section be adjacent the second V-channel and that the end section be proximate the second V-channel and be angled away from the sheave.

1. A line hauler for hauling seafood traps, the hauler comprising a stand, a first pulley, a second pulley and a sheave, the sheave comprising two sides and a V-groove therebetween, a drive shaft, an electric motor for driving the sheave rotationally with the drive shaft, the improvement being a dualler plate and retainers, the dualler plate comprising a circular plate, a central aperture for accepting the drive shaft and apertures corresponding to apertures in the sheave for accepting the retainers, the dualler plate dividing the V-groove into a first V-channel and a second V-channel, such that in use, a line is fed from the upper side of the first pulley to an upper side of the first V-channel, to a lower side of the second pulley, and returning to the sheave on an upper side of the second V-channel.

2. The line hauler of claim 1, wherein the V-channels are about 1.5 inches deep and about 0.5 inches wide at an outer edge.

3. The line hauler of claim 2 further comprising an O-ring seated in the second V-channel.

4. The line hauler of claim 3, wherein the dualler plate is about 8 inches to about 11 inches in diameter.

5. The line hauler of claim 2, further comprising the line, the line being fed from the upper side of the first pulley to the upper side of the first V-channel, to the lower side of the second pulley, and returning to the sheave on the upper side of the second V-channel.

6. The line hauler of claim 5, further comprising a line coiler, the line coiler comprising a first section affixed to the line hauler, a second section at right angles to the first section, sloped about 16 to about 21 degrees towards the sheave and adjacent at least the second V-channel and an end section at about 43 to about 47 degrees to the second section, proximate the second V-channel and angled away from the sheave, wherein the line is threaded between the first V-channel and line coiler and is fed over the line coiler from the second V-channel, such that in use, the line coiler is urged to coil.

7. The line hauler of claim 1, further comprising a line coiler, the line coiler having an attachment member attached to the line hauler, a directing member extending therefrom proximate the second V-channel and configured to direct a line from the second V-channel, and an end member extending from the second member, the end member essentially parallel to the V-channels.

8. A kit for use with a line hauler, the line hauler comprising a stand, a first pulley, a second pulley and a sheave, the sheave comprising two sides and a groove therebetween, a drive shaft, an electric motor for driving the sheave rotationally with the drive shaft, the kit comprising: a rotatable member for increasing friction on a line; retainers; and a line coiler.

9. The kit of claim 8, wherein the line coiler comprises a first section for affixing to the line hauler, a second section angled at about 85 degrees to about 95 degrees to the first section and a third section that is angled at about 43 to about 90 degrees from the second section to encourage a line to remain on the line coiler and return back over the second section, such that in use, the line coiler extends outward and downward from the line hauler.

10. The kit of claim 8, wherein the rotatable member is a dualler plate, the dualler plate comprising a circular plate, a central aperture for accepting the drive shaft and apertures corresponding to apertures in the sheave for accepting the retainers, the dualler plate for dividing the groove into a first V-channel and a second V-channel, such that in use, a line is fed from the upper side of the first pulley to an upper side of the first V-channel, to a lower side of the second pulley, and returning to the sheave on an upper side of the second V-channel.

11. The kit of claim 9, wherein the first section is about 4 to about 6 inches long, the second section is at about 85 degrees to about 95 degrees to the first section, sloped about 16 to about 21 degrees from the plane of the first section and about 1.25 inches to about 2.25 inches long and the third section at about 43 to about 47 degrees to the second section and about 0.4 to about 1 inch long.

12. The kit of claim 8 further comprising an O-ring for seating in the second V-channel.

13. The kit of claim 10, wherein the dualler plate is a stainless steel plate.

14. A line coiler for use with a line hauler, the line hauler comprising a stand, a first pulley, a second pulley and a sheave, the sheave comprising two sides and a groove therebetween, a drive shaft, an electric motor for driving the sheave rotationally with the drive shaft, the line coiler comprising a first section for affixing to the line hauler, a second section angled at about 85 degrees to about 95 degrees to the first section and a third section that is angled at about 43 to about 90 degrees from the second section to encourage a line to remain on the line coiler and return back over the second section, such that in use, the line coiler extends outward and downward from the line hauler.
